(19) United States
(12) Patent Application Publication
(10) Pub. No.: US 2009/0058315 A1
(43) Pub. Date: Mar. 5, 2009

(54) Control module

(75) Inventor: Urs Baeumle, Hong Kong (HK)

Correspondence Address: JACKSON WALKER, L.L.P., 112 E. PECAN, SUITE 2400, SAN ANTONIO, TX, 78205, US

(73) Assignee: Permalight (Asia)Co., Ltd.

(21) Appl. No.: 11/895,782

(22) Filed: Aug. 27, 2007

(51) Int. Cl. H05B 41/36

(52) U.S. Cl. 315/291

(57) ABSTRACT

An electric light control module comprising: a first interface for connection to a power supply unit; a second interface for connection to a light source unit; a programmable control circuit operable to store a predetermined sequence of two or more instructions, each instruction including one or more individually programmable parameters, and to control the transmission of electrical signals between the first interface and the second interface in accordance with the predetermined sequence thereby controlling the operation of a light source connectable to the second interface, and one or more user input devices capable of manual activation connected to the control circuit to alter at least one of the one or more individually programmable parameters.

### DESCRIPTION OF THE INVENTION

The present invention relates to a control module for an electric lighting system. In particular, the present invention relates to a control module for use with an electric torch.

Electric torches of various different types are well known. A basic electric torch comprises a power supply, a switch and a light source connected together in a circuit and housed in a casing which may be portable. Although the term “torch” shall be used to describe the present invention and prior art it will be appreciated that the term “torch” could easily be replaced by, for example, any one of the following terms: “flashlight”, “lantern”, “pen-light” or any other relevant form of electric lighting equipment.

Electric torches traditionally use conventional filament light bulbs connected in a circuit with a mechanical switch and a power supply. In the absence of any power regulation circuitry, the brightness of the light bulb varies in proportion to the voltage across the power supply to which the light bulb is connected. If the batteries become discharged, then the brightness (or intensity) of the light emitted by the light bulb will decrease. Thus, traditional electric torches (especially battery operated devices) suffer from an inability to maintain a steady and reliable brightness over a long period of operation.

Inherent problems are also associated with the use of conventional filament light bulbs. These light bulbs produce large amounts of light from a filament (ie. a piece of wire) through which a current is passed. The resistance of the filament causes the filament glow, thus emitting light. However, the operation of such a light bulb is dependent upon the heat which is produced in the filament. This heat can cause evaporation of the filament material and, thus, limit the life-span of a light bulb and make the bulb inherently fragile. In addition, the heat which is produced is a by-product (ie. an unwanted product) of the torch and a large amount of power is lost as heat rather than being used “usefully” to produce light.

Developments such as halogen light bulbs have gone some way to alleviate the problems with the traditional light bulbs. However, halogen light bulbs also have disadvantages such as high operating temperatures.

More recently, developments have been made in the field of light emitting diodes (LEDs) and the commercial production of white, colour, infrared (IR) and ultraviolet (UV) LEDs has now been realised. These LEDs have been incorporated into torches as replacements for conventional filament light bulbs—sometimes as direct replacements with little alteration to the rest of the torch and in other examples with associated control circuit (which will be discussed below). The use of LEDs brings with it the advantages of increased lifespan, decreased power consumption, and increased durability.

In addition, advances in power regulation, integrated circuits and microcontrollers have lead to the development of more advanced functionality and control circuits for lighting devices such as, for example, torches.

A modern electric torch may employ a single LED, or one or more clusters of LEDs powered by a battery pack. However, in contrast to traditional filament light bulb torches, the battery pack is rarely connected directly to the LEDs, as connection to a circuit of this type would, in many cases, result in a current being applied through the LED which is beyond its operational parameters and would cause its failure or malfunction.

Indeed, due to the current-voltage relationship of LEDs it is preferable to connect LEDs to a current source rather than a voltage source. A current source for use in a torch usually comprises power regulation circuitry connected to one or more batteries. In the most basic form this power regulation circuitry comprises a simple resistor. In other more complex examples, the power is regulated through the control circuit including, for example, a microprocessor or microcontroller, memory elements, pulse width modulation circuitry and integrated circuits designed for power regulation or timing functions.

Modern power regulation circuitry allows for the incorporation of different operating characteristics into a single device. An example of a modern control mechanism and power regulation circuit for a torch is shown in WO00/22890. This Patent document describes control circuitry for the operation of, for example, a torch. The disclosed control circuitry comprises an integrated circuit including a microcontroller, a timer, and a power regulating switch. Inputs from the user of the torch enter into the system through a mechanical switch connected to the microcontroller. The microcontroller can be programmed with multiple modes of operation which allow the switch to be used for on/off operation, initiating the transmission of an emergency signal, or initiating gradual dimming of the torch.

Torches produced according to WO00/22890, however, have a number of failings. In particular, the integrated circuits described in that document must be included in the design of a torch from its onset. It is not possible to adapt an existing torch easily to operate utilising the integrated circuit. Furthermore, user input into the integrated circuit of WO00/22890 is difficult because only one input switch is provided and no indication (other than the operation of the torch) is provided to show the user the current mode of operation. For example, a user will not necessarily be aware that a dimming mode of operation has been selected until the torch begins to dim.

The integrated circuit of WO00/22890 also lacks flexibility in its design and operation. For example, once the integrated circuit is incorporated into a torch design, it is not possible to upgrade that torch to carry out functions which were not envisaged when the torch and integrated circuit were originally produced. In addition, the number of functions which the integrated circuit can perform are limited.

The present invention attempts to ameliorate the problems associated with the prior art.

Accordingly one aspect of the present invention provides, an electric light control module comprising: a first interface for connection to a power supply unit; a second interface for connection to a light source unit; a programmable control circuit operable to store a predetermined sequence of two or more instructions, each instruction including one or more individually programmable parameters, and to control the transmission of electrical signals between the first interface and the second interface in accordance with the predetermined sequence thereby controlling the operation of a light source connectable to the second interface, and one or more user input devices capable of manual activation connected to the control circuit to alter at least one of the one or more individually programmable parameters.

Preferably, the programmable control circuit comprises a microcontroller unit.

Advantageously, the programmable control circuit further comprises a receiving unit operable to receive radio frequency or infrared signals.

Conveniently, the programmable control circuit further comprises a display unit operable to display information concerning the operation of the module to a user.

Preferably, the programmable control circuit further comprises an intensity control unit operable to receive a desired intensity level and determine a parameter of a driving signal used to regulate the transmission of a signal from the first interface to the second interface.

Advantageously, the programmable control circuit further comprises an environmental sensor operable to detect a variety of environmental conditions within a predetermined volume around the module, for example, movement, chemical agents, smoke, radiation, water levels, humidity, and electromagnetic radiation.

Conveniently, the programmable control circuit further comprises an encryption unit operable to receive a user input from the one or more user input devices and encode the user input.

Preferably, the encryption unit is operable to receive and store a user input as a programmable sequence of one of more instructions.

Advantageously, the parameters include an intensity level and a time period.

Preferably, the programmable control circuit further comprises a memory unit operable to store one or more programmable sequences.

Conveniently, the programmable control circuit further comprises a transmission unit operable to transmit radio frequency or infrared signals.

Advantageously, the at least one parameter includes one or more of a start time of the instruction, a stop time of the instruction, a duration of the instruction, and a signal level of the instruction.

Advantageously, at least one of the one or more user input devices is sensitive to the proximity of another object.

Preferably, at least one of the one or more user input devices is a switch activated by contact with another object.

In order that the present invention may be more readily understood, embodiments thereof will be described, by way of example, with reference to the accompanying drawings, in which:

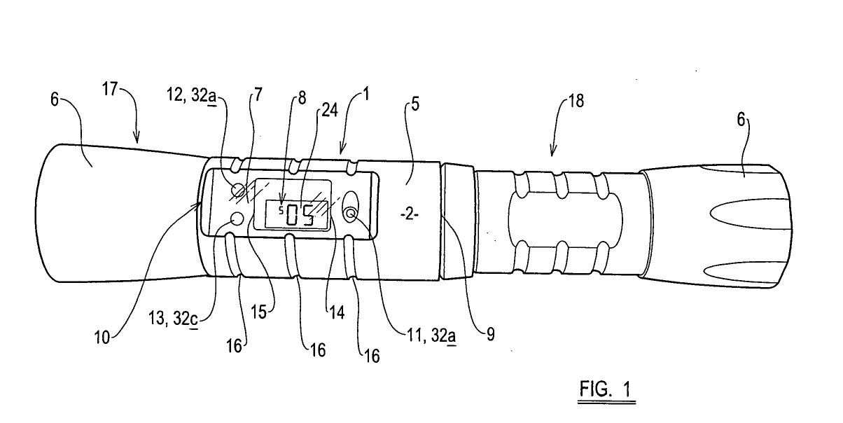

FIG. 1 shows a module according to an embodiment of the present invention attached to a torch;

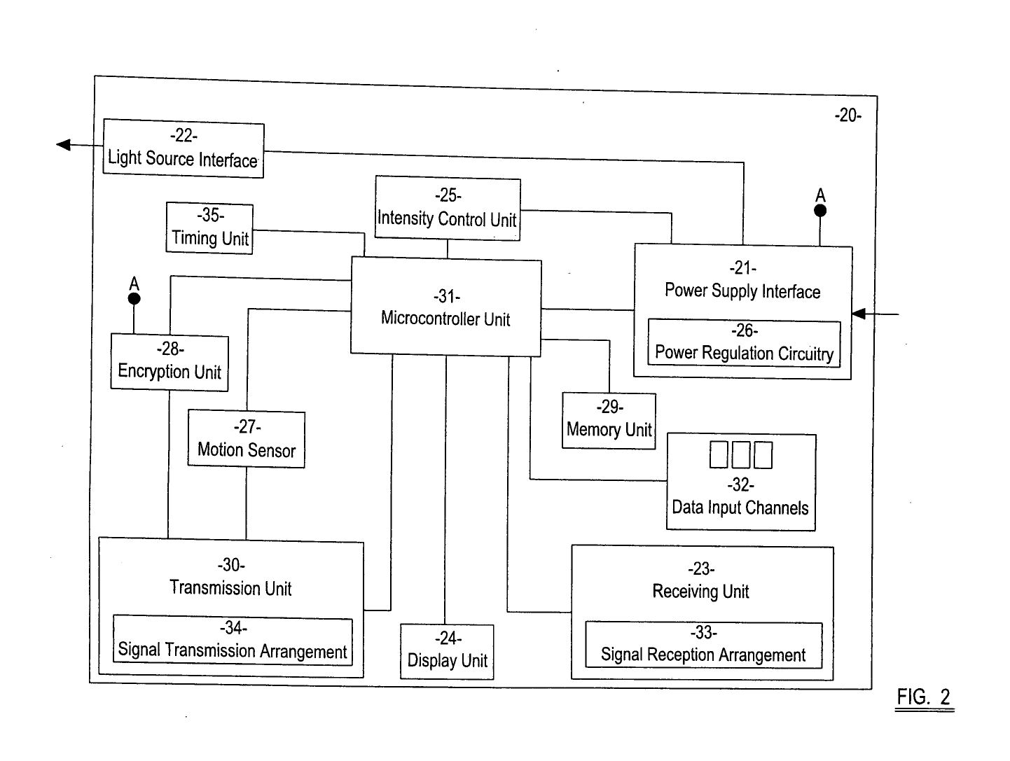

FIG. 2 shows an example of the components of a control circuit according to an embodiment of the present invention.

The control module will be described with reference to the example embodiment shown in FIG. 1.

The module 1 comprises a main body section 2 having a first attachment arrangement at a first end 9 and a second attachment arrangement at a second end 10 thereof (the first and second ends of the main body section 2 correspond to first and second ends of the module 1 which oppose each other across a length of the main body section 2).

The main body section 2 of the module 1 is substantially cylindrical and has a diameter, a curved outer circumferential wall 5, and a hollow circuit cavity (not shown). Preferably, the diameter of the main body section 2 is substantially identical to the diameter of a torch 6 with which the module 1 is to be utilised.

The module 1 has a display window 7, comprising a flat indented section, in the curved outer wall 5 of the main body section 2. A display window hole 8 is located in the flat indented section of the outer wall 5; the hole 8 extends through an entire thickness of the wall 5 into the hollow circuit cavity of the module 1. Preferably, the hole 8 is generally rectangular in shape and is covered in transparent material which extends over the entire area of the flat indented section in the main body 2 of the module 1.

The display window 7 has a longitudinal axis parallel to a longitudinal axis of the main body section 2 of the module 1 and is located closer to the second end 10 of the module 1 than the first end 9 thereof.

Located around the display window hole 8 are three button holes 11, 12, 13, such that one button hole 11 is adjacent a first edge 14 of the display window hole 8 (between the first edge 14 of the display window hole 11 and the first end 9 of the module 1) and the other two buttons holes 12, 13 are adjacent a second edge 15 of the display window hole 8 (between the second edge 15 of the display window hole 8 and the second end 10 of the module 1). For the avoidance of doubt, the first 14 and second edges 15 of the display window hole 8 are arranged opposite to one another across a length of the display window hole 8 and correspond to the first 9 and second 10 ends of the module respectively.

The two button holes 12, 13 adjacent the second edge 15 of the display window hole 8 are aligned with an axis which is perpendicular to the longitudinal axis of the main body section 2 of the module 1 and are an equal distance from both the second edge 15 of the display window hole 8 and the second end 10 of the module 1.

All of the button holes 11, 12, 13 extend through the entire thickness of the curved outer wall 5 of the main body 2 of the module 1 into the circuit cavity thereof.

The main body section 2 of the module 1 is preferably constructed out of metal. Suitable metals include, for example, aluminium, titanium, or stainless steel. However, it will be appreciated that the main body section 2 of the module 1 may be constructed out of any strong material including plastic or ceramic materials.

The control module 1 may also include, in or on the main body section 2, an arrangement 16 which increases the frictional coefficient between a user's hand and the control module—thus preventing the module and attached torch from slipping out of the user's hand. Preferably, the arrangement 16 is provided as grooves in the outer curved surface 5 of the main body section 2.

The material covering the display window 7 is generally constructed out of strong, hard plastic but it is envisaged that the display window 7 may also be constructed out of, for example, glass, toughened glass, sapphire crystal, or other hard and substantially transparent materials. In some embodiments of the present invention the display window 7 covering material includes button holes which are substantially identical to and aligned with corresponding button holes 11, 12, 13 in the main body section 2 of the module 3 (around the display window hole 8).

The first attachment arrangement (at the first end 9 of the module 1) is suitable for connection to at first interface of a torch 6. The second attachment arrangement (at a second end 10 of the module 1) is suitable for attachment to a second interface of the torch 6.

The first interface of the torch 6 may be, for example, the connection interface of a light source module 17 of the torch 6 and the second interface may be, for example, the connection interface of a battery or power supply module 18 of the torch 6. Thus, it will be appreciated that in some instances, the first and second interfaces of the torch 6 are capable of being connected together to form a single complete torch 6 comprising a light source module 17 and a battery module 18 (a user interface, such as an on/off switch, may be located in either the light source 17 or battery module 18 but is usually in the battery module 18). However, in the case of the operation of the present invention the control module 1 may be connected between the light source module 17 and the battery module 18 of a torch 6 to form an adapted torch.

Each attachment arrangement includes suitable transmission interfaces (not shown) to allow the control module 1 to communicate with the torch modules 17, 18 to which it is connected. These transmission interfaces include connectors (not shown) suitable to transmit, for example, information signals, control signals, or power. The connectors can include, for example, physical “wired” connectors or inductively coupled connectors.

It will be appreciated that the specific attachment arrangements of the control module 1 according to the present invention will be dependent upon the type of torch 6 to which the control module 1 is to be attached (in particular, the first and second torch interfaces).

It should be understood that the control module may be integrally incorporated into the torch or may be an “add-on” feature. As an “add-on,” it attaches to attachment arrangements on the light source module and the battery module of a standard torch.

Preferably, the attachment arrangements include threaded sections (not shown) to allow the control module 1 to be attached to the modules 17, 18 of the torch 6 by mating the threaded sections of the control module 1 with corresponding threaded sections (not shown) on the first and second torch interfaces.

Although the description above discusses the use of embodiments of the control module 1 of the present invention with a battery module 18 and a light source module 17 of a torch 6, it will be understood that the control module 1 may be attached to any part of a torch 6 with one or more suitable interfaces. For example, the two attachment arrangements of the control module 1 may be located at one end of the control module 1 and form a one or more separate attachment arrangements. The single end of the control module 1 could, in this embodiment, be attached to a torch 6 though a single torch interface. Indeed, embodiments of the invention may be utilised on lighting devices which are not torches 6 and suitable attachment arrangements will depend upon the electric light device to which the module 1 is attached.

A control circuit 20, as will be described below, is located in the hollow circuit cavity of the control module 1. Preferably the control circuit 20 is securely located within the circuit cavity.

The control circuit 20 preferably comprises a microcontroller unit 31, and is operable to control the transmission of signals (including power signals) from a power supply interface 21 (along with respective power regulation circuitry 26) to a light source interface 22. Additional elements which are coupled to and form part of the control circuit 20 may include a receiving unit 23 (suitable to receive, for example, radio frequency or infrared signals), a display unit 24, an intensity control unit 25 (which is preferably connected to the power regulation circuitry 26 of the power supply interface 21), a motion sensor 27, an encryption unit 28, a memory unit 29, and a transmission unit 30 (suitable to transmit, for example, radio frequency or infrared signals).

The microcontroller unit 31 is also connected to three data input channels 32 which are preferably provided in the form of the three user input devices 32 which may be manual activated. The three user input devices 32 are secured such that they are substantially aligned with the button holes 11, 12, 13 in the main body section 2 of the control module 1. It will be appreciated that a number of different types of user interface device can be utilised in the present invention. Examples of devices which may be utilised include light sensitive devices, heat sensitive devices, proximity sensors, contact sensors, capacitive sensors, mechanical switches or movement sensitive devices. Preferably light sensitive or mechanical switches are utilised.

For the avoidance of doubt, the term “manually activated” in relation to the user input devices 32 indicates that the input devices 32 are capable of activation by a user without the need, for example, for an additional electronic programming tool.

The microcontroller unit 31 is preferably operable to do one or more of the following: manage the interactions of the other circuit elements of the control circuit 20, carry out processing of information, and control the information which is displayed using the display unit.

The power supply interface 21 (which is operable for connection to, for example, the battery module 18) includes connections to the second attachment arrangement of the module 1 and is suitable for connection to a wide range of different supply voltages. Preferably, these voltages range between 6 and 12 volts; however, it is envisaged that the power supply interface 21 will be suitable to utilise voltages between 1 volt and 24 volts.

The power supply interface 21 includes power regulation circuitry 26 to convert the input power into a suitable output power form. Elements of the power regulation circuitry 26 may be controlled by the microcontroller unit 31. It will be appreciated that a number of different power regulation circuits may be utilised in order to achieve the operation described and, in its most basic form, the power regulation circuitry 26 may comprise a simple resistor and an electronic switch such as a transistor. Preferably, the power supply interface 22 is operable to determine the power supply voltage. The exact form of the power regulation circuitry 26 will not be described herein but will be apparent to a skilled person.

Light source interface 22 allows the control module 1 to connect to a light source 17 (at the second attachment arrangement of the module 1). The light source interface 22 can, in some embodiments, form part of the power regulation circuitry 26 of the power supply interface 21 and is, in any case usually connected to the power regulation circuitry 26. Preferably, the output of the light source interface 22 is used as a direct power supply to for light source module 17 attached to the control module 1. In other embodiments it is envisaged that the output of the light source interface 22 will, in fact, be used as an input to further power regulation circuitry (not shown) which may be located externally to the control module 1 and could, for example, form part of the light source module 17. It will, therefore, be appreciated that references to variations in the operation of a light source 17, in fact, indicate variations in the output of the light source interface 22 which controls the light source 17.

The receiving unit 23 includes a signal reception arrangement 33, the form of which will depend upon the type of signal being received. Preferably, the signal being received is either an infrared signal or a radio frequency signal. If the signal being received is a radio frequency signal, then the reception arrangement 33 will include an antenna of a suitable size to receive signals of the desired frequency. The antenna is preferably incorporated into the control module 1. In some embodiments of the present invention an antenna interface (not shown) will be provided in the control module 1 to allow an external antenna to be connected to the receiving unit 23.

If the signal to be received is an infrared signal, then the receiving unit 23 will include an infrared detection device similar to that found in, for example, a video cassette recorder. Some embodiments of the present invention include both infrared and radio signal reception arrangements and their associated circuitry (including, in some instances, an antenna interface for an external antenna).

In embodiments of the present invention the receiving unit 23 includes, is connected to, or is operable to be connected to a remote control signal reception unit (not shown). The remote control signal reception unit is operable to receive a control signal which can be used to turn the module 2 on or off, or to program the operation of the module 2 to the same extent as a local user of the control module 2. Preferably, the remote control signal reception unit is operable to use Dual-Tone Multi-Frequency (DTMF) technology.

In some embodiments of the present invention, the remote control signal reception unit is connected to a remote control signal transmission unit (not shown). The remote control signal transmission unit can be incorporated into the transmission unit 30. The remote control signal transmission unit is preferably operable to transmit a signal to remotely control another module 2. Advantageously, the remote control transmission unit is operable to use Dual-Tone Multi-Frequency (DTMF) technology.

The display unit 24 preferably comprises a liquid crystal display (LCD) which, when the control circuit 30 is secured within the control module 1, is visible through the display window hole 8 in the outer casing 5 of the module 1.

It is envisaged that other forms of display device may be utilised in the display unit 24; for example, the display unit 24 may comprise a thin-film transistor display device, light emitting diode or organic light emitting diode devices, surface-conduction electron-emitter display devices or any other type of suitable display device.

Preferably, the display unit 24 includes a backlight which may be controlled by the user or by may be automatic (based upon a recorded ambient light level—for which a light level sensor (not shown) will be required as part of the control circuit 30). In addition, the backlight may have an automatic switch-off; for example, the backlight may turn off after a certain period of operation.

Advantageously, the display unit 24 has a display device which requires little power to operate, is durable, and does not deteriorate significantly with age.

The intensity control unit 25 may be linked to the power regulation circuitry 26 of the power supply interface 21 or to the microcontroller unit 31 or to both. In some embodiments, depending upon the required intensity level, the microcontroller unit 31 will provide instructions to the intensity control unit 25 which will, in turn, control elements of the power regulation circuitry 26 to control the current and/or voltage supplied to or across elements of the light source interface 22. In other embodiments, the microcontroller 31 will provide instructions to the intensity control unit 25 which will return a control signal to the microcontroller 31 which will be used to operate the power regulation circuitry 26.

For example, a desired brightness level may be transmitted by the microcontroller unit 31 to the intensity control unit 25 by use of a binary number. The intensity control unit 25 may, upon receipt of the binary number, determine the frequency of a series of driving pulses of a certain voltage across the elements of the light source interface 22 such that the intensity of the light output by the light source 17 is controlled in accordance with the desired brightness level. For example, an electronic switch (not shown) in the power regulation circuitry 26 may be switched at a frequency which, according to the operating characteristics of the light source 17, produces the desired brightness level.

It will be appreciated that the intensity control unit 25 can also be utilised to effect strobe, fade, dim or other similar modes of operation of the light source 17.

An environmental sensor unit 27 may comprise one or more of a number of different well-known sensing elements operable to detect environmental conditions within a predetermined space or volume around the module. These elements could include, for example, a capacitive motion sensing device, a light dependent resistor based motion sensor device, a charge-coupled device based system, an infrared motion detector, an ultrasonic motion detector, a chemical agent detector, a smoke detector, an electromagnetic radiation detector, or a water level/humidity detection device.

The environmental sensor unit 27 may be linked to the transmission unit 30 for the transmission of a pre-recorded signal. Alternatively, the sensor unit 27 may be used as an input device for the encryption unit 28 which, in turn, may be linked to the power regulation circuitry 26 of the power supply interface 21 or the transmission unit 30 to produce an appropriate output (eg. a sequence of encoded light signals or radio frequency signals).

The transmission unit 30 can be utilised to transmit one or more transmission signals which may comprise, for example, radio frequency signals, or infrared signals.

The transmission unit 30 includes a signal transmission arrangement 34, the form of which will depend upon the type of signal being transmitted. Preferably, the signal being transmitted is either an infrared signal or a radio frequency signal. The signal may be in set configurations such that ratio frequency codes may be transmitted automatically. Examples include the transmission of an SOS distress signal, release of brief messages in Morse code, as described below. If the signal being transmitted is a radio frequency signal, then the transmission arrangement 34 will advantageously include an antenna of a suitable size to transmit signals of the desired frequency. The antenna is preferably incorporated into the control module 1. In some embodiments of the present invention, an antenna interface (not shown) will be provided in the control module 1 to allow an external antenna to be connected to the transmission unit 30.

If the signal to be transmitted is an infrared signal, then the transmission arrangement 34 will include an infrared transmission device similar to that found in, for example, the remote control unit for a television. Some embodiments of the present invention include both infrared and radio signal transmission arrangements 34 and their associated circuitry (including, in some instances, an antenna interface for an external antenna).

In some embodiments of the present invention the transmission unit 30 and the receiving unit 23 are integrated such that they share common transmission 34 and reception 33 arrangements such as an antenna.

In some embodiments of the present invention one or both of the receiving unit 23 and the transmission unit 30 comprises an interface which allows the module 1 to be connected to a receiving or transmission unit which is separate from the module 1.

The encryption unit 28 includes circuitry suitable to convert a user's inputs into an encoded signal. For example, a user's inputs could be encrypted into Morse code or into a programmable sequence of signals. The output of the encryption unit 28 can be linked to one or more of the transmission unit 30, the microcontroller 31, the power supply interface 21 (and the power regulation circuitry 26), and the light source interface 22. The output of the encryption unit 28 could be used to, for example, control a light source 17 in accordance with the encrypted signal or to transmit an encrypted radio frequency signal. The encryption unit 28 preferably includes memory elements (not shown), for example, to store a message or to store an encryption algorithm. In addition, the encryption unit 28 may include a timing circuit (not shown). Preferably the outputs of the timing circuit are shared by other units of the control module 1.

In some embodiments, the control module 1 includes a separate timing unit 35. The timing unit 35 is preferably powered by its own power source (not shown) such as a battery. The timing unit 35 may include a memory element (not shown) and may be able to record and track one or more of the following: the time, day, date, or the year. Preferably, the timing unit 35 has a time resolution of between 1 ns and 1 ms.

Preferably, the memory unit 29 of the control circuit 30 can be used by any of the components of the control circuit 30 for the storage of information concerning, among other things, their current mode of operation. Advantageously, the memory unit 29 (or, indeed, any of the references to memory within this document) can comprise one or more either volatile or non-volatile memory elements (not shown) or a combination of both. Preferably, non-volatile memory is used.

It will be appreciated that the circuit elements of the control circuit 30 can be connected together in a number of different configurations in accordance with aspects of the present invention.

Example modes of operation of the control module 1 will now be discussed. It will be appreciated that, although the operation is described with reference to a torch 6 to which the module 1 is attached, the invention may be utilised with any suitable electric light source 17. Furthermore, it will be appreciated that other modes of operation can be used and that the modes of operation are merely example modes of operation. It will be appreciated that references to operation of the output of the torch 6 require a corresponding output from the light source interface 22 and such references should be construed accordingly.

A first mode of operation will hereinafter be referred to as a user programmable mode of operation. The user programmable mode of operation may have a number of different sub-modes of operation which will be described below.

A user may select brightness or intensity levels of, for example, 25%, 50%, 75%, or 100% of the maximum light output for the light source. If the brightness level is set at a lower brightness than 100% of the maximum brightness, then the user may override the setting by activating one of the user interface devices of the control module to automatically return the brightness level to maximum brightness.

Sequences of signals may be produced by utilising the encryption unit 28 (sequence mode). For example, the light source may be operated in a strobe or fade mode. The encryption unit 28 can be utilised to program a sequence of consecutive fading and/or strobing modes in a repeating or one-off sequence.

The sequence and intervals between and the brightness of the light pulses forming a strobing mode and fading mode may be programmed by the user. Once activated, the programmed sequence will play and may be stopped by a further input by the user (to the user interface devices or even the motion sensor), when the sequence has played a predetermined number of times, or when a predetermined length of time has passed since an initiation event (such as a user input or reception of a signal through the receiving unit 23).

The control module 1 can be operated as a warning light controller, the control sequence comprising a predetermined number of pulses at a predetermined frequency—a warning light mode of operation. Alternatively, the transmission unit 30 may also be operated in a similar fashion on its own or in combination with the light source 17. Preferably, the warning light mode of operation has a pulse frequency of 5 Hz ±0,5 Hz. Advantageously, the light source 17 will be operated at maximum power when in warning light mode. The warning light mode can be activated by a user input (through, for example, the user interface devices or the environmental sensor) or by reception of a signal through the reception unit. Once activated, the warning light mode will play and may be stopped by a further input by the user, when the sequence has played a predetermined number of times, or when a predetermined length of time has passed since an initiation event (such as a user input or reception of a signal through the receiving unit 23).

The control module 1 can be operated in a “dead-man” switch mode of operation such that a timer is reset every time the motion sensor detects movement (using the motion sensor). If a timer reaches the end of a predetermined period (which may be user defined between, for example, 1 and 10 minutes) a different mode of operation may be entered: such as, the warning light mode or sequence mode.

An SOS mode of operation may be activated by user input or reception of a signal through the receiving unit 23, for example. The SOS signal is, advantageously, 46 CFR 161.013-7; compliant, and may comprise a light sequence or a signal output through the transmission unit 30, or a combination of both.

A location mode is a sub-mode of the sequence mode and, in this mode of operation, the control unit 1 is operable to control a light source 17 to output a predetermined sequence at predetermined intervals at a given brightness level. The brightness level is preferably the lowest light level available (eg. 25% of maximum).

A low power mode of operation is generally activated if the power supply interface 21 detects the power supply voltage drop below a predetermined threshold. In some embodiments of the present invention the predetermined threshold can be set by the user, or is set automatically by the control module 1 based upon factors including a record of previous power supply voltage levels. In this mode of operation a low level battery indicator is displayed on the display unit 24 and the intensity of the torch 6 to which the control module 1 is attached is altered (preferably, the intensity of the torch 6 is stepped down over a period of time as the power supply voltage drops).

A bypass mode of operation allows the input from the power supply interface 21 to be directly connected to the light source interface 22. Thus the control module 1 is bypassed and has no substantial affect upon the operation of the torch 6 to which it is attached or connected.

The timing unit 35 can be used to operate a date and time mode. During this mode of operation one of the time records kept and tracked by the timing unit are displayed on the display unit. Preferably, these records include the current time and date.

During a timing mode of operation the timing unit can be utilised to time the period between two user inputs (the inputs being, for example, through the user interface devices 32 or the motion sensor 27).

During a transmission mode of operation the control module 1 is operable to output a signal through the transmission unit 30. This signal may operate as, for example, an emergency beacon.

The control mechanism whereby a user can input information and instructions into the control module 1 will now be described.

As discussed above the control circuit includes three data input channels 32 (which are preferably user input devices or buttons) for user input and a display unit 24 to provide indications of the operation and current state of the control module 1. It is envisaged that user input can also come from the motion sensor 27, or the receiving unit 23.

The three user input devices 32 preferably comprise a main control button 32a, and first 32b and second 32c selection buttons. The main control button 32a is used to select a particular mode of operation, enter a command, confirm an entry, exit a display screen or delete an entry. The first 32a and second 32b control buttons are used to scroll through options which are displayed using the display unit 24.

The module 1 may be programmed with a number of different settings or programmable sequences. In this instance it shall be assumed that there are four independent settings (settings a, b, c, and d). The programming of the settings is controlled by the encryption unit 28 of the module 1. Each setting can comprise a program which operates the control module 1 and any torch 6 attached thereto in a predetermined manner. The settings may be stored in the memory unit 29 of the control module 1. It will be appreciated that there could be any number of different settings depending on, for example, the amount of storage space in the memory unit 29.

In this instance, any of the four independent settings can include a number of frames (preferably, up to 9 frames). Each frame comprises a timed period of operation and when any particular setting is selected the module 1 (and hence the torch 6) will operate, for a predetermined length of time, in accordance with the settings described in each frame in sequential order. It will be appreciated the there could be any number of frames depending on, for example, the amount for storage space in the memory unit 29.

Each frame can include a time period for its duration of operation before the next frame in the sequence is utilised and an intensity level.

Below is an example of a sequence or steps which can be taken to program one of the independent settings (ie. in programming mode):
1. If no setting has been programmed and stored in the memory unit 29, the control module 1 starts in bypass mode (“bP”) when first activated. A relatively long activation of the main control button 32a (preferably for over 5 seconds) will light the backlight of the display device and the letter “a” will flash on the display device. This indicates that setting “a” is ready to be programmed.
2. A relatively short activation of the main control button 32a (generally less than 5 seconds) will cause the numeral “1” to be displayed in the display. In this example the numeral “1” indicates frame 1.
3. A relatively short activation of the main control button 32a can be used to verify that it is desired to program frame “1” of setting “a”. Following this short press of the main control button 32a “0.1 sec” will be displayed in the display device—the module 1 is now operable to receive information regarding the time setting (ie. duration) of frame “1” of setting “a”.
4. Activation of the first 32b and second 32c selection buttons can be used to increase or decrease the time period displayed in the display device respectively. Preferably the time period will vary by 0.1 sec for every activation of one of the selection buttons 23b, 32c. In this example, the time period can be varied between 0.1 sec and 9.9 sec; however, for the purposes of this example a time period of 0.5 sec is selected. A relatively short activation of the main control button 32a confirms the 0.5 sec setting and this information is processed by the encryption unit.
5. The display device now displays “99%”; this is the light intensity setting. The value displayed on the screen can be increased or decreased by utilising the first 32b and second 32c control buttons—as described in relation to the previous stage. Preferably, the value varies from 100% to 0% in steps of approximately equal value (eg. 100%, 75%, 50%, 25%, and 0%). For the purposes of this example a value of 75% is selected. A relatively short press of the main control button 32a confirms the selection and this information is processed by the encryption unit of the module. “2” (Frame 2) appears on the display device.
6. The display device now displays “2”, indicating that it is possible to program frame “2” of setting “a”. It is possible to either program frame “2” in a similar manner to the programming of frame “1” discussed above, or to exit the programming mode. To exit the programming mode the main control button 32a is activated for a relatively long period of time.

The encryption unit 28 of the module 1 may store the programmed sequence in the memory unit 29 of the module 1 or may store the program temporarily in a memory element (not shown) which is internal to the encryption unit 28.

In this example, upon exiting the programming mode the setting identifier (“a”) will be displayed in the display device and the sequence stored as “a” will be played (ie. it will enter a setting play mode).

When the sequence is played the control module 1 will operate the torch 6 to which it is attached in accordance with the programmed information. In this case, the torch 6 will be activated at 75% of maximum intensity for 0.5 seconds.

It will be understood that each frame of a setting comprises an individual instruction for the operation of a light source module 17 controlled by the control module 1 and that two or more of the instructions of a setting comprise a sequence of instructions.

Any setting (a, b, c or d) can be programmed to play once, repeat continuously, play for a predetermined length of time, or play for a predetermined number of repetitions.

In this example of the operation of the control module 1 the setting play mode can be exited with a relatively short activation of the main control button 32a. The module 1 will then re-enter the bypass mode of operation and “bP” will be displayed in the display device.

In this example of the programming and operation of the control module 1 according to embodiments of the present invention it will be understood that any of the other programmable settings can be programmed in a similar manner and can be selected by utilising the selection control buttons 23 at the end of step 1 shown above. Preferably, when the control module 1 is activated the display device will display (and offer for selection) the last program setting which was used by the module 1. It will be appreciate that this information must, therefore, be stored in a memory element within the control module 1. Preferably this information is stored in the memory unit 29 of the control circuit 20.

It is envisaged that each frame of a particular programmable setting could be further programmed to function in accordance with a further predetermined program. For example, frame “1” of setting “a” could be programmed to be a strobe at 75% intensity and a frequency of 1 Hz, frame “2” of setting “a” could be programmed to be the Morse code for the letter “P”, frame “3” of setting “a” could be programmed to be the Morse code for the letter “A”, frame “4” of setting “a” could be programmed to be the Morse code for the letter “T”, and so on.

It will be appreciated that a module 1 according to embodiments of the present invention can, therefore, be programmed to operate in a complex manner which would be difficult for an unskilled operator to achieve using a traditional torch 6 with only a simple mechanical on/off switch.

In the example operation of the control module 1 which has been described above it will be understood that a setting can be selected for play by activating the main control button 32a for a relatively short period of time after initial activation of the module 1. In addition, a programmed setting can be deleted or altered either by re-writing the setting or by erasing the setting altogether. An example of the possible operation of the present invention for several different erasing processes is shown below:

To change the value of one or more of the frames in a programmed setting the following sequence can be followed:

1. A relatively long activation of the main control button 32a until “a” is displayed in the display device (settings “b”, “c”, or “d” can be selected using the selection buttons 32b,32c).

2. A relatively short activation of the main control button 32a will confirm the selection and “1” will be displayed in the display device.

3. A relatively short activation of the main control button 32a will confirm that it is desired to change the programmed values for frame “1” of setting “a”. Alternatively, the selection control buttons 32b,32c may be used to select a different frame, followed by a relatively short activation of the main control button 32a to confirm the selection.

4. It is then possible to alter the programmed values for the selected frame and proceed in the same manner as described above in relation to the initial programming of the settings.

To delete a single programmed setting, steps 1 to 3 above can be followed; however, instead of selecting a frame for which it is desired to change the programmed values, “dE” should be selected—“dE” is displayed after the final frame stored for that setting. A relatively short activation of the main control button 32a confirms that it is the desired intention to delete the selected setting. The setting will be deleted from its storage location. A relatively long activation of the main control button 32a exits the deletion mode and the display device will display the reference letter of one of the remaining settings or “bP” if there are no remaining settings.

To delete all of the programmed setting, step 1 above should be followed; and “dE” selected. In this case “dE” is displayed after the final stored setting. All of the settings can then be deleted by a relatively short activation of the main control button 32a.

In general the state of the module 1 after initial activation or after the exiting of a programmed setting is referred to as the main control mode.

Advantageously, the control module 1 may also be pre-programmed with an SOS Morse code program. This program can, for example, be selected by activating the main control button 32a and both of the selection control buttons 23b, 32c simultaneously for a relatively long period of time. Under the operation of this program the control module 1 will display “SOS” in the display device and will control any torch 6 to which it is attached to flash in accordance with the Morse code for the letters “S”, “O” and “S” in sequence and at maximum intensity, until the power supply of the torch 6 is depleted.

It will be appreciated that the present invention may be utilised with a number of different types of light source modules 17 including LED or Xenon based torches 6 or lighting equipment.

The present invention can be designed for attachment to a single type of torch 6, or a single control module 1 can be designed for attachment to several different types of torches 6. As such, the control module 1 may include additional attachments arrangements which are suitable for connection to the modules 17, 18 of different types of torch 6.

The control circuit 20 may include elements (not shown) which can detect the particular model of torch 6 to which it is attached and this information can be used to vary operational parameters of, for example, the power supply interface 21, or any of the other components of the control circuit 20.

For the avoidance of doubt the power supply module 18 may be exhaustible power supply such as a battery.

It will be understood that the control module of the present invention may be self-contained. In other words, the operation of the module, including the programming of the module and its activation, may be carried out without an additional device such as an external electronic programming unit; the control circuit and other electronic components of the module may be completely contained within the confines of the module 1.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. An electric light control module comprising:
a first interface for connection to a power supply unit;
a second interface for connection to a light source unit;
a programmable control circuit operable to store a predetermined sequence of two or more instructions, each instruction including one or more individually programmable parameters, and to control the transmission of electrical signals between the first interface and the second interface in accordance with the predetermined sequence thereby controlling the operation of a light source connectable to the second interface, and
one or more user input devices capable of manual activation connected to the control circuit to alter at least one of the one or more individually programmable parameters.

2. A module according to claim 1, wherein the programmable control circuit comprises a microcontroller unit.

3. A module according to claim 2, wherein the programmable control circuit further comprises a receiving unit operable to receive radio frequency or infrared signals.

4. A module according to claims 2, wherein the programmable control circuit further comprises a display unit operable to display information concerning the operation of the module to a user.

5. A module according to claim 2, wherein the programmable control circuit further comprises an intensity control unit operable to receive a desired intensity level and determine a parameter of a driving signal used to regulate the transmission of a signal from the first interface to the second interface.

6. A module according to claim 2, wherein the programmable control circuit further comprises an environmental sensor operable to detect environmental conditions within a predetermined volume around the module.

7. A module according to claim 2, wherein the programmable control circuit further comprises an encryption unit operable to receive a user input from the one or more user input devices and encode the user input.

8. A module according to claim 7, wherein the encryption unit is operable to receive and store a user input as a programmable sequence of one of more instructions.

9. A module according to claim 8, wherein the parameters include an intensity level and a time period.

10. A module according to claim 2, wherein the programmable control circuit further comprises a memory unit operable to store one or more programmable sequences.

11. A module according to claim 2, wherein the programmable control circuit further comprises a transmission unit operable to transmit radio frequency or infrared signals.

12. A module according to claim 2, wherein the at least one parameter includes one or more of a start time of the instruction, a stop time of the instruction, a duration of the instruction, and a signal level of the instruction.

13. A module according to claim 2, wherein at least one of the one or more user input devices is sensitive to the proximity of another object.

14. A module according to claim 2, wherein at least one of the one or more user input devices is a switch activated by contact with another object.
